(19) United States
(12) Patent Application Publication
(10) Pub. No.: US 2001/0045458 A1
(43) Pub. Date: Nov. 29, 2001

(54) BIOMETERIC SYSTEM FOR VERIFYING THE USER OF A CREDIT/IDENTIFICATION CARD BY A MINIATURE AUTONOMOUS FINGERPRINT CAPTURE AND VERIFICATION SYSTEM

(76) Inventor: STEPHEN T. POLANSKY, Vancouver (CA)

Correspondence Address: STEPHEN T. POLANSKY, C/O UNITRANSACT CORPORATION, 381 - 280 NELSON STREET, VANCOUVER, BRITISH COLUMBIA, V5B 2E2, CA

(21) Appl. No.: 09/361,529

(22) Filed: Jul. 27, 1999

Related U.S. Application Data
(60) Provisional application No. 60/094,256, filed on Jul. 27, 1998.

(51) Int. Cl. G06K 5/00

(52) U.S. Cl. 235/382

(57) ABSTRACT

The present invention and process provides a method and device for verifying an authorized user of a credit/identification card via Internet utilizing a biometric miniature autonomous fingerprint capture and verification system device. The process includes the steps of scanning the owner's credit card information stored on the card, including fingerprint information, scanning the user's fingerprint, and comparing the scanned information to information of the card owner stored on a computer database in communication with the device. If scanned fingerprint, the information on the credit card/identification card and the information corresponding to the owner of the card which is stored in the database do not match, the card is rejected.

### TECHNICAL FIELD

The invention relates to methods and devices for verifying an authorized user of a credit/identification card, and more particularly to a method and device which utilizes a biometric miniature autonomous fingerprint capture and verification system for verifying the authorized user of the credit card. Once stored on the microchip or magnetic strip the information can then be read into the apparatus along with the actual fingerprint to be compared. The apparatus will then automatically make a comparison check to see if they match.

### BACKOROUND ART

Credit card fraud—the use of a credit card, bank card, debit card, identification card etc. by someone other than the authorized user, is a widespread problem for which many solutions have been attempted. There is a growing need to reduce credit card fraud, as well as to provide better methods to screen persons entering restricted areas, and allow for secure use of credit cards over the Internet for making purchases or bank transactions. Putting an image of the authorized user on the card is one solution, but it does not prevent the manufacture of fraudulent cards, and is not a solution well-suited for Internet transactions where there is no physical interaction between the parties. Providing the user with a personal identification (PIN) number is not foolproof in that the user may forget the number or an unauthorized user may be able to detect the number. Various approaches have also been taken to prevent unauthorized use of credit cards by verifying the identity of the card-holder using physical features of the card holder such as fingerprints or retinal patterns. For example, U.S. Pat. No. 5,513,272 issued Apr. 30, 1996 to Bogosian, Jr. and U.S. Pat. No. 5,598,474 issued Jan. 28, 1997 to Johnson, disclose methods of verifying the user of a credit card by including a fingerprint on the card and comparing the fingerprint of the user to that stored on the card to determine the authenticity of the user.

Among the objects of the present invention therefore is the provision of an improved method of utilizing a biometric property, namely a fingerprint, that unlike a password or PIN, cannot be lost, stolen, or recreated. A further object of the invention is to provide a method and system for verifying an authorized user of a credit/identification card which is specifically related to Internet electronic commerce, which can ascertain the identity of a person who has the legal right to use a credit/identification card and whether or not the card has been modified, so that an unauthorized user is prevented from using the card. Also among the objects of the present invention is the provision of an improved device for verifying an authorized user of a credit/identification card which has an autonomous fingerprint capture and verification system and has both a magnetic strip reader and microchip read/writer devices.

Other objects, features and advantages of the invention shall become apparent as the description thereof proceeds when considered in connection with the accompanying illustrative drawings.

### DISCLOSURE OF INVENTION

The present invention provides a method for verifying an authorized user of a credit/identification card comprising the steps of:

a) inserting the credit/identification card into a PCMCIA (Personal Computer Memory Card International Association) fingerprint capture and verification device having a plurality of sensors devices, the card including a microchip and a surface having a magnetic strip thereon which has information relevant to the owner of the card, such as credit card identification number and other personal data and fingerprint digital code;

b) comparing the information stored on the magnetic strip of the card to information of the owner stored on a central computer server and database in communication with the device. The device rejects the user's card if the information on the magnetic strip does not match the information of the owner stored on the database;

c) scanning information from the microchip of the card;

d) comparing the microchip information on the card with the information of the owner's fingerprint representation stored on the database. The device rejects the card from the user if the information on the microchip does not match that stored on the database;

e) obtaining a fingerprint of the user;

f) scanning the fingerprint of the user by a fingerprint thermal sensor;

g) comparing the fingerprint of the user to the fingerprint on the microchip and to the fingerprint of the owner stored in the database to ensure authorized use of the card. The device rejects the card if the fingerprint scanned by the fingerprint thermal sensor does not match the fingerprint on the microchip and in the database. Upon matching the user's fingerprint to the figerprint on the microchip and in the database, the device allows the user to use the card for desired purpose. Other transactional and statistical information may also be stored on the microchip and compared to the information in the database.

An apparatus for carrying out the method of the present invention comprises an information strip-scanning device for scanning the information strip of the card and means for comparing such information with information of the owner stored on the database in communication with the apparatus. The apparatus rejects the card from the user if the information on the card does not match the corresponding information of the owner of the card which is stored in the database. The apparatus includes a microchip reader/writer device for scanning the biometric information of the owner of the card, such as fingerprint information, as well as other operational information, and means for comparing the fingerprint information to the corresponding information of the owner of the card which is stored in the database. The apparatus rejects the card from the user if the information scanned from the microchip on the card does not match with the database. The apparatus and database may include encryption/decryption means for encrypting/decrypting data transmissions between the apparatus and the database. The apparatus and database may further include compression/decompression data transmissions between the apparatus and the database. The apparatus further includes a thermal fingerprint sensor device for obtaining a fingerprint of the user by scanning the fingerprint of the user, and means for comparing the scanned fingerprint information to the corresponding information of the owner of the card which is stored on the microchip and in the database.

### BRIEF DESCRIPTION OF DRAWINGS

In the drawings which illustrate the best mode presently contemplated for carrying out the present invention:

FIG. 1 is a flow chart illustrating a method for verifying an authorized user of a credit and/or identification card of the present invention;

FIG. 2 is a block diagram illustrating a system for carrying out the method of the present invention;

FIG. 3 is a PCMCIA fingerprint capture and verification system card of the present invention;

FIG. 4 is a block diagram of an apparatus for carrying out the method of the present invention shown in FIG. 3

FIG. 5 is a credit/identification card of the present invention including microchip device;

FIG. 6 illustrates the reverse side of the credit/identification card shown in FIG. 5

FIG. 7 is a view of a thermal imaging fingerprint sensor chip;

FIG. 8 is a view of a thermal imaging fingerprint sensor actual size of finger; and

FIG. 9 is a view of fingerprint image capturing several successive images.

Corresponding reference numerals designate corresponding parts throughout the several views of the drawings.

### BEST MODE(S) FOR CARRYING OUT THE INVENTION

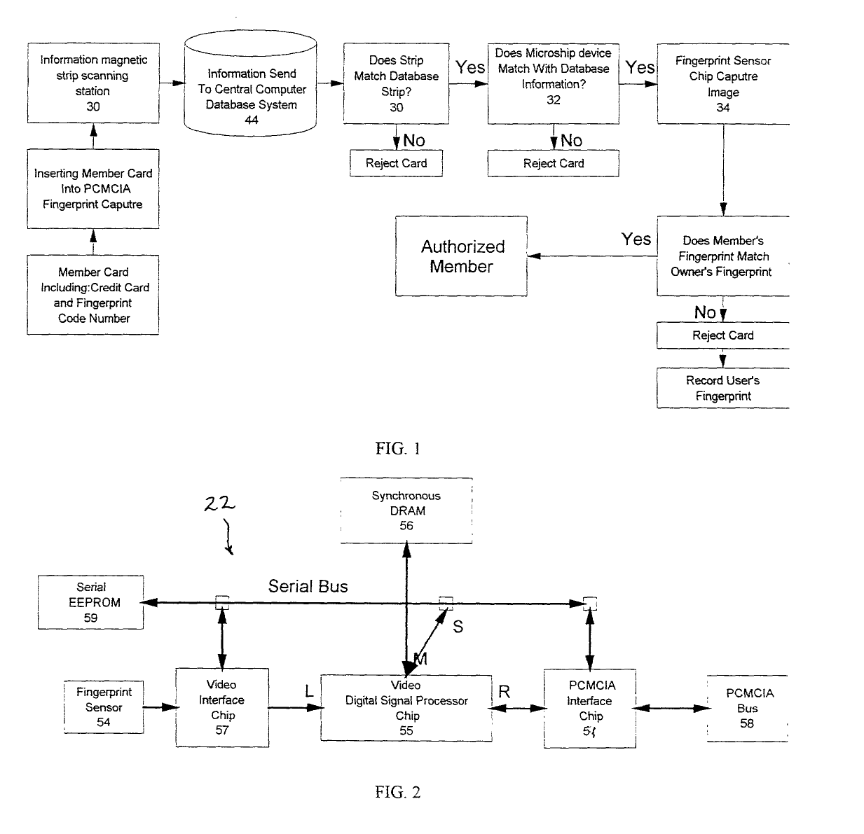

Referring now to the drawings, there is illustrated in FIG. 1 a method for verifying the authorized user of a credit/identification card 12 (illustrated in FIG. 5). Preferably, the front side of the card 12 includes microchip 18 having fingerprint 80 of the owner of the card in unique identification code and also may have other historical operational data of the card's use, such as dates and amounts of historical transactions. The card 12 has a reverse side 15 (FIG. 6) which has an information strip 16 such as a magnetic strip or bar code, imprinted thereon which has information relevant to the owner of the card, such as an identification and/or credit card code number and other personal data. The information strip 16 and microchip 18 may be impressed directly onto card 12 and protected by a laminate or the like. It should be understood that the method of the present invention is applicable to any situation where it is desired to verify or authenticate that the user of the card 12 is the owner of the card. The method of the present invention is especially suited to verifying users of credit card information. The method may be used to verify the identity of authorized persons desiring access to a restricted area (e.g. hospital, corporate facilities, doors, gates, etc.), and other applications (e.g. encryption and communication of user-identification information; user identity verification via pen, notebook, network and desktop computers; user identity verification via portable devices, customer verification at POS point-of-sale terminals and ATMs (asynchronous transfer mode) machines, access control to computers; building and offices and airline gates, voter registration, electronic commerce on Internet, portable and inexpensive law enforcement, corrections and immigration applications). FIG. 2 illustrates an apparatus generally indicated at 22, for carrying out the method of the present invention, the apparatus 22 being described in detail after the description of the method of the present invention.

Referring now to FIG. 1, the method initially comprises the step of inserting the card 12 into an apparatus, such as apparatus 22, having a plurality of scanning stations, namely an information magnetic strip scanning station 30, a microchip scanning station 32, and a fingerprint scanning station 34. As will be described in greater detail below, the apparatus 22 may embody any number of designs, so long as it is capable of performing the respective verification steps of the method.

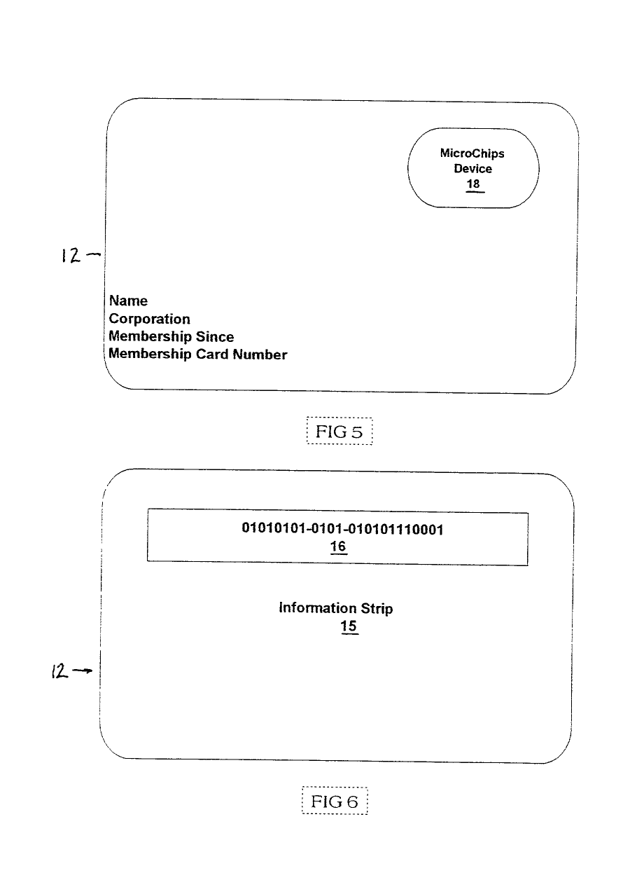

After being inserted into the apparatus 22, the card 12 enters an information magnetic strip scanning station 30 for scanning the strip 16 of the card 12 to verify the information of the card 12 including the identification number. This information is sent to a video digital signal processor chip 55 (FIG. 2) which compares the information stored on the information strip 16, to include the card owner's identification number, to information of the owner stored on at least one accessible database 44 (FIG. 4) in communication with the central computer database via PCMCIA bus 58 (FIG. 2) of the apparatus 22. In order to insure complete security of data transmissions between the apparatus and the database, both the apparatus and database preferably include encryption/decryption devices for encrypting and decrypting data transmission in compress mode. If the information on the strip 16 of the card 12 matches the information stored in the database 44 for that particular card, the card 12 is examined by the next station (i.e., the microchip scanning station 32). However, the apparatus 22 rejects the card 12 from the user if the information on the card does not match the corresponding information relevant to the owner of the card, which is stored in the database 44.

Next, the card 12 is examined by a microchip scanning station 32 in which the microchip device 18 of the card 12 is scanned. The purpose of using the microchip 18 of the card 12 is to store and verify the owner's fingerprint information code, in addition to other statistical and historical data in digital numeric sequence which is sent to the external central computer via PCMCIA bus 58 (FIG. 2) which compares the digital numeric sequence representing the microchip database of the card to information from a prior scan of the card which is stored on the aforementioned database 44 or other accessible database in communication with the video DSP chip 55 of the apparatus 22. If the digital numeric sequence of the card 12 matches the digital numeric sequence stored in the database for that particular card, the card 12 is examined by the next station. However, the apparatus 22 reject the card 12 from the user if the digital numeric sequence of the card does not match the digital numeric sequence, which is stored in the database 44. As with the information scanning station 30, the information may be stored in database 44 of the apparatus 22 until the apparatus is serviced at which time the cards presented by unauthorized users and rejected by the apparatus may be properly addressed. By comparing historical data stored in the microchip, such as dates and amounts of recent transactions, counterfeit cards which were copied from the owner's card without his knowledge and then subsequently used can be detected.

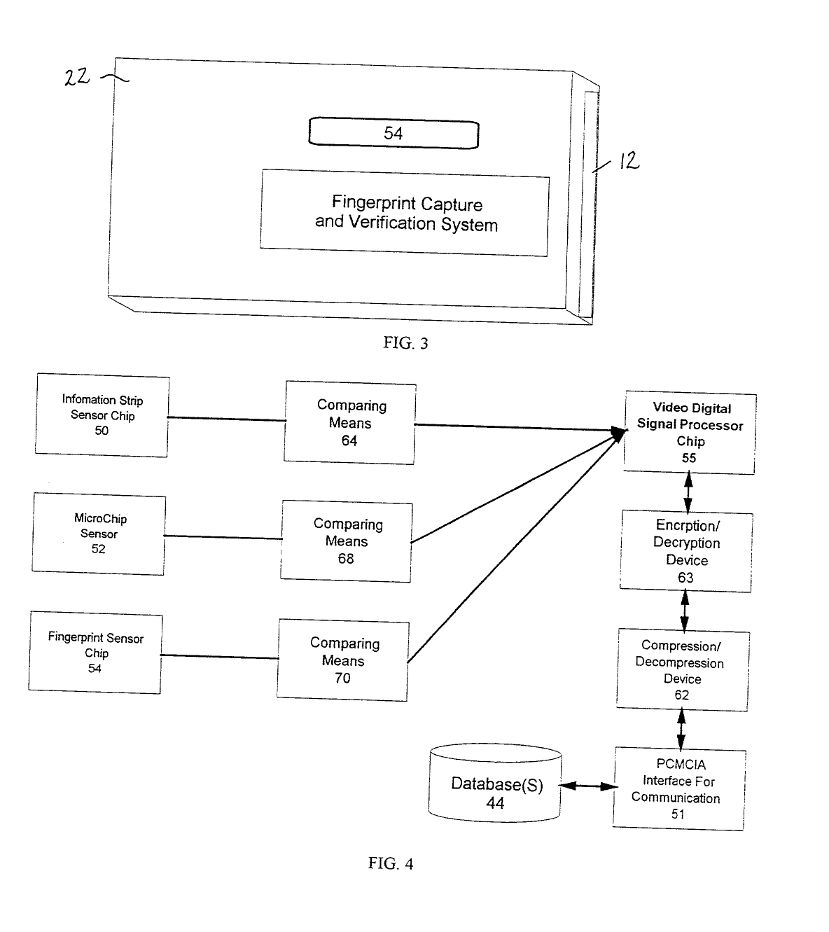

As illustrated in FIG. 1, the card 12 is next examined by fingerprint scanning station 34. This step of the method of the present invention requires the user of the card 12 to provide a fingerprint code stored on microchip device 18 which is compared to the fingerprint of the user scanned at 54 in FIG. 3 and to a fingerprint of the owner of the card in the aforementioned database 44, or an external central computer database in communication with the video DSP chip 55 of the apparatus 22, to ensure authorized use of the card 12. As with the information strip and microchip scanning stations 30, 32, the apparatus 22 rejects the card 12 from the user if the fingerprint scanned by the fingerprint scanning station does not match the fingerprints on the card and in the database 44. If the fingerprint of the user matches the fingerprints on the station 14 and in the database 44, the apparatus 22 may allow the user to use the card 12 for a desired purpose, or the card 12 may be re-examined by subsequent stations if a more exacting level of verification is required.

Turning now to FIG. 4, there is illustrated the apparatus 22 of the present invention, which comprises an information scanning device 50, a microchip scanning device 52, a fingerprint scanning device 54, a video digital signal processor 55 and central computer (64,68,70). Central computer (64,68,70) obtains the information gathered by the devices 50, 52, 54 and compares it to information stored on the database 44, or, as mentioned above, a plurality of separate databases in communication with the central computer (64,68,70). The apparatus 22 and database 44 preferably include encryption/decryption and compression/decompression devices 63 and 62 for encrypting and decryption data transmissions via compression mode therebetween. The encryption devices 63 effectively prevent someone from tapping into the Internet and telephone lines to illegally access or copy the digital transmissions during the verification process. Thomson-CSF Semiconductors Cedex-France, Oxford Micro Devices Shelton, Conn., USA and Datoteck, Inc. of Dallas, Tex., manufacture encryption devices 63 of the type contemplated. The apparatus 22 may embody different forms. However, it is envisioned that it would be constructed similarly to the miniature (extended-length type-2) PCMCIA card with an approximate size 4.6 inches long per 2.1 inches high per 0.25 inches deep, or the size of a credit card.

More specifically, the information strip scanning device 50 is provided for scanning a magnetic strips of the card 12. As illustrated, the central computer (64,68,70) includes means for comparing the information contained in the strip 16 of the card 12 to information of the owner stored on the database 44. If the information on the card 12 does not match the information of the database 44, the apparatus 22 rejects the card 12. The information strip scanning device 50 may be any of the commercially available scanners for scanning bar codes, such as a scanner sold by Symbol Technologies, Inc., Bohemia, N.Y. USA under the model no. PDF 417.

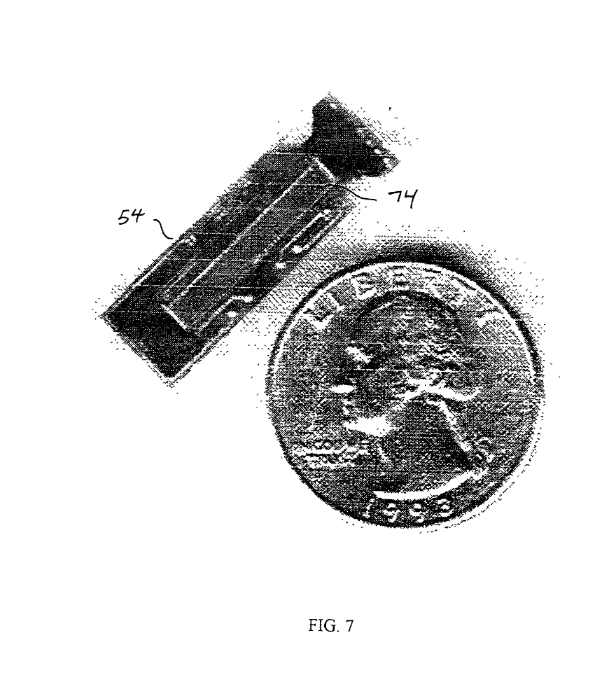

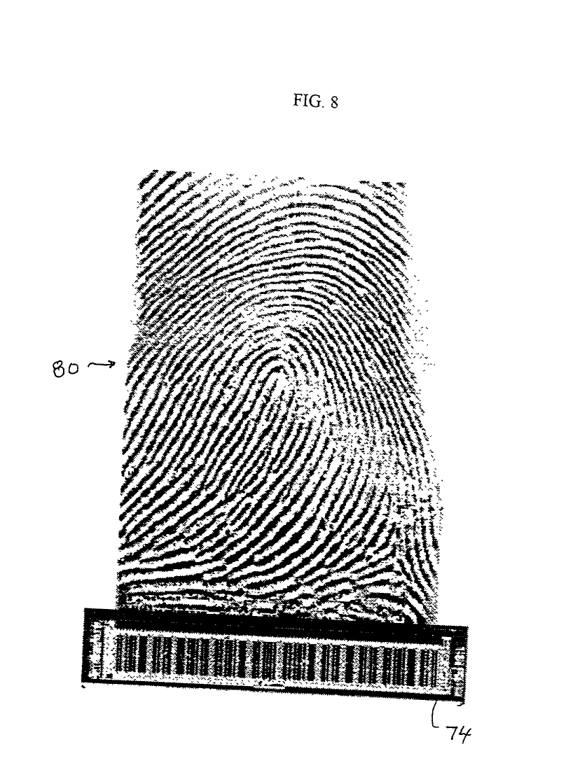

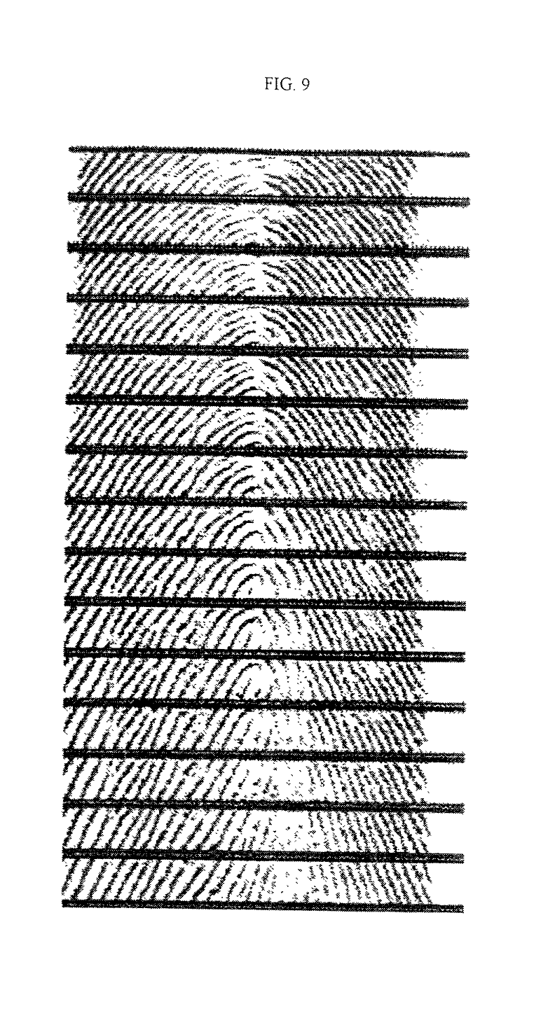

The thermal fingerprint sensor device 54 has a pad 74 (FIGS. 7 and 8) across which the user of the card 12 inserted into device 22 (FIG. 3) sweeps his finger for obtaining a fingerprint of the user. The fingerprint scanning device 54 scans the fingerprint of the user as obtained by the pad and sends it to the video interface chip 57 (FIG. 2) which converts analog output from fingerprint sensor to the digital format used by video DSP chip 55 (FIG. 2). PCMCIA interface chip 51 passes information between the video chip 55 and host central computer, which includes comparing means 70 (FIG. 4), via a PCMCIA bus 58 for comparing the fingerprint of the user to the microchip 18 on the card 12 and to a fingerprint of the owner of the card in the database 44. If the fingerprint 18 of the user of the card does not match the fingerprint stored in microchip 18 on the card 12 or the fingerprint in the database 44, the apparatus 22 rejects the card.

The thermal imaging fingerprint sensor is a 500-dpi live-scan sensor which images a person's fingerprint in real-time through direct finger contact with the protected silicon chip. No optics or light sources are needed, as the fingers own heat produces all that is necessary to image the fingerprint. The fingerprint sensor is able to offer a linear array (17.2 mm×17.5 mm) with a surface area of under 0.5 cm² and is less than 2 mm thick. The user of the card sweeps a finger across the thermal fingerprint sensor's pad 74, which scans the fingerprint of the user. In this way, the fingerprint sensor actually images a fingerprint 10-15 times larger than its surface by capturing several successive images, as shown in FIG. 9, and reconstructing them into a full fingerprint, as shown in FIG. 8, via an algorithm. Comparison means 70 compare the fingerprint of the user to the fingerprint on the card to a fingerprint of the owner of the card in the database to ensure authorized use of the card. The apparatus rejects the card from the user if the fingerprint scanned by the fingerprint sensor chip does not match the fingerprints on the card and in the database. Thus, upon matching the user's fingerprint to the fingerprints on the card and in the database for ensuring the user of the card is the owner of the card, the apparatus allow the user to use the card a desired purpose.

The apparatus includes a 32-bit (DSP) video digital signals processor chip device for controlling all communications and provides all images capture and data processing. A 32-bit wide 100 MHz synchronous 4 megabytes DRAM 56 (dynamic random-access memory)—very high speed memory chip is provided for all temporary data and program storage, capable of moving data very quickly at 400 megabytes per second (MB/S). A Video input chip 57 converts analog output from the fingerprint sensor to the digital format utilized by video DSP chip 55. A serial bus port EEPROM 59 (electronically erasable programmable read-only memory)—non-volatile semiconductor memory is provided for storage of the operating system, application program and fingerprint data. Its contents are transferred to synchronous DRAM 56 upon bootup. PCMCIA interface chip 51

passes information between video DSP chip 55 and the host central computer via a PCMCIA bus 56. A serial bus enables video DSP chip 55 to control interfaces and read/write to serial EEPROM 59.

The fingerprint sensor device 54 may also include a recording feature in which the fingerprint of the unauthorized user is recorded for later use, such as comparing it to fingerprints in other databases. This recording feature would assist in the apprehension of the unauthorized user. The fingerprint sensor device 54 may be of the type sold by Thomson-CSF Semiconductors Specifics, Saint Egreve Cedex, France.

Video DSP chip 55 controls all communications and provides all images capture and data processing. Video DSP 55 (FIG. 2) is a versatile, stand alone, fully user-programmable, general-purpose building block for real-time digital video signal processing. The video DSP chip 55 (FIG. 2) may be of the type sold commercially by Oxford Micro Devices, Inc. Shelton, Conn., USA.

The apparatus 22 described thus far is capable of achieving the method of the present invention, i.e., capable of comparing the information on the strip 16 of the card 12 to information about the owner on the database 44, determining whether the card 12 has been altered, and comparing the fingerprint of the user with the fingerprint store in microchip 18 on the card 12 and the fingerprint in the database 44. The apparatus 22 autonomously captures and verifies the fingerprint of the user. The apparatus 22 does not need necessarily a connection to an external host computer, but can operate autonomously, for example as a hotel room door access. The reference user fingerprint data can be stored in non-volatile memory, synchronous DRAM 56 shown in FIG. 2, or loaded on the fly from the PCMCIA bus to database 44 or loaded to microchip databank 18. The apparatus 22 is a real-time operating system running on embedded video DSP that runs applications written in Java language.

The apparatus 22 can be connected via PCMCIA bus connection 58 to any commercially available laptop computer or desktop computer. The computer plugs into an Internet ATM backbone or Cell Relay via modem or ISDN basic rate interface (BRI) interface, which grants user admittance via an Internet service provider to secure electronic commerce, corporate Intranet, on-line database information center, import and export transactions, insurance, currency exchange, direct on-line products marketing, international business information center, direct online business transactions, banking business transactions, global network marketing product and services, automated travel agency ticketing and cruise and resorts servers and the like.

The fingerprint conversion process utilizes high-speed thermal fingerprint sensor 54 obtaining (e.g., non-interpolated) 500 per 500 dpi image scans at 256 levels of gray (e.g., 8 bits). The system continually and automatically performs sophisticated statistical sampling and verification steps to guarantee that a quality of fingerprint conversion is being created. With video DSP 55 high-speed processing capability, the fingerprint image stored in microchip device 18 and non-volatile memory 56, the transmission of information to database on external computer will minimize the interruption of critical, ongoing user functions. The fingerprint software may be purchased from Cogent System, Inc. Alhambra, Calif., USA. A central processor/server is required to operate this software. DSP is deployed alongside the fingerprint silicon chip sensor to create a fully programmable system device to acquire and reconstruct a series of images from the fingerprint sensor, verify the fingerprint against one or few stored fingerprints, and encrypt/decrypt, compress/decompress and communicate the result. Therefore, an entire fingerprint capture, storage, verification, encryption, compression and communication system is built into the space of credit card-size calculator. It should be observed that the method and apparatus 22 of the present invention are therefore capable of verifying the authorized user of credit/identification card, as well as determining whether the card has been altered.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. A method for verifying an authorized user of a credit/identification card comprising the steps of:
i) inserting said card into an apparatus having a plurality of sensors and a scanning station, the card including a microchip device containing the fingerprint digital code of the owner of the card and having a magnetic strip thereon which has information corresponding to the owner of the card including a credit card identification number;
ii) scanning the magnetic strip of the card at an information strip scanning station of said apparatus;
iii) comparing the information stored on the magnetic strip of the card to information of the owner stored on at least one accessible database in communication with said apparatus, the apparatus rejecting the card from the user if the information on the card does not match the corresponding information of the owner of the card which is stored in the database;
iv) scanning the fingerprint of the user at a fingerprint scanning station; and
v) comparing the scanned fingerprint of the user to the fingerprint on the microchip of the card and to a fingerprint of the owner of the card in the database, the apparatus rejecting the card from the user if the fingerprint scanned by the fingerprint sensor device does not match the fingerprints on the card and in the database; whereby, upon matching the user's fingerprint to the fingerprints on the card and in the database said apparatus allows the user to use the card for a desired purpose.

2. The method of claim 1 further comprising the step of recording the fingerprint of the user if it does not match the fingerprint on the card or the fingerprint of the owner of the card.

3. An apparatus for verifying an authorized user of a credit/identification card including a surface having a magnetic strip thereon which has information corresponding to the owner of the card, and a microchip device storing a fingerprint digital code of the owner of the card, said apparatus a comprising;
i) an information strip scanning device for scanning the information strip of the card;
ii) means for comparing the information contained in the magnetic strip to information of the owner stored on at least one accessible database in communication with said apparatus, the apparatus rejecting the card from the user if the information on the card does not match the corresponding information of the owner of the card which is stored in the database;
iii) a microchip device storing information including a fingerprint image of the owner of card;
iv) means for comparing the microchip database information to information scanned from fingerprint sensor of the owner stored on at least one accessible database, the apparatus adapted to reject the card from the apparatus if the information on the microchip does not match the corresponding information of the owner of the card which is stored in the database;
v) a fingerprint sensor device for obtaining fingerprint data of a user; and
vi) means for comparing the fingerprint of the user to the microchip database on the card and with fingerprint of the owner of the card in the external database, whereby if the fingerprint information of the user of the card does not match the fingerprint stored in the microchip database on the card or the fingerprint in the database, the apparatus rejects the card.

4. The apparatus of claim 3 further comprising means for recording the fingerprint of an unauthorized user.

5. A method of verifying an authorized user of a credit/identification card comprising the steps of:
i) reading an information strip on the card, said information strip having information corresponding to the owner of the card;
ii) comparing said information to a corresponding set of information stored in a remote database computer center, whereby said card is withheld if said information does not match said corresponding set of information stored in the remote database;
iii) obtaining information regarding a user's transactions and storing said information on a microchip device on said card;
iv) comparing said microchip information and corresponding information on a remote database, whereby said card is withheld if said obtained microchip information does not match said information stored in said remote database;
v) obtaining a digitally encoded image of physical attribute of the user of the card;
vi) comparing said obtained digital encode image of said physical attribute of said user to a corresponding image of said physical attribute of said owner stored in said remote database, whereby said card is rejected if said obtained digital encoded image of said physical attribute does not match said image of said physical attribute of said owner stored in said remote database, and further whereby said obtained digital encode image of said physical attribute is recorded if said obtained digital encoded image of said physical attribute does not match said stored digital encoded image of said physical attribute, said user being allowed to conduct a desired electronic transaction if said obtained digital encoded image of said physical attribute of said user matches said stored image of said physical attribute of said owner.

6. The method of claim 5 wherein said physical attribute comprises a fingerprint.

7. The method of claim 6 further comprising the step of obtaining an digital encoded image of a second physical attribute of said user, and comparing said obtained digital encoded image of said second physical attribute of said user to a corresponding digital encoded image of a second attribute of said owner stored in said remote database, whereby said card is rejected if said obtained digital encoded image of said second physical attribute does not match said corresponding stored digital encoded image of said second physical attribute, and further whereby said obtained digital encoded image of said second physical attribute is recorded if said obtained digital encoded image of said second physical attribute does not match said corresponding stored digital encoded image of said second physical attribute, said user being allowed to conduct a desired electronic transaction if said obtained digital encoded image of said second physical attribute of said user matches said digital encoded image of said second physical attribute of said owner.

8. Apparatus for verifying an authorized user of a credit/identification card comprising;
i) means for reading an information magnetic strip on said card, said information magnetic strip having information relating to the owner of the card;
ii) means for communicating with a remote database having corresponding set of information relating to said owner of said card;
iii) means for comparing said information to said corresponding set of information stored in said remote database, said card being rejected by said apparatus if said information does not match corresponding set of information stored in the remote database;
iv) means for obtaining a digital encoded fingerprint identification of said card to a corresponding digitized encoded fingerprinted identification of said card stored in microchip database and in said remote database, said card being rejected by said apparatus if said obtained digitized encoded fingerprint identification does not match said corresponding digitized encoded fingerprint identification stored in said remote database;
v) means for obtaining an digital encoded image of a physical of a physical attribute of the user of the card;
vi) means for comparing said obtained digital encoded image of said physical attribute of said user to a corresponding digital encoded image of said physical attribute of said owner stored in said remote database, said card being rejected by said apparatus if said obtained digital encoded image of said physical attribute does not match said stored digital encoded image of said physical attribute; and
vii) means for recording said obtained image of said physical attribute if said obtained image of said physical attribute does not match said stored digital encoded image of said physical attribute;
and wherein said user is allowed to conduct a desired electronic transaction if said obtained digital encoded image of said physical attribute of said user matches said stored digital encoded image of said physical attribute of said owner.

9. The apparatus of claim 8 wherein said physical attribute of said user comprises a fingerprint.

10. The apparatus of claim 8 further comprising means for obtaining an digital encoded image of fingerprint identification of a second physical attribute of said user, and means for comparing said obtained image of said second physical attribute of said user to a corresponding digital encoded image of second physical attribute of said owner stored in said remote database, said card being rejected if said obtained digital encoded image of said second physical attribute does not match said corresponding stored image of said second physical attribute, said apparatus still further comprising means for recording said obtained digital encode image of said second physical attribute if said obtained digital encoded image of said second physical attribute does not match said corresponding stored digital encoded image of said second physical attribute, said user being allowed to conduct a desired electronic transaction if said obtained digital encoded image of said second physical attribute of said user matches said stored digital encoded image of said second physical attribute of said owner.

11. The apparatus of claim 8 further comprising means for encrypting/decrypting data transmissions between said apparatus and said remote database.

12. The apparatus of claim 8 wherein said second physical attributes comprises means for compression/decompression data transmissions between said apparatus and said remote database.

13. The method of claim 1 further comprising the step of encrypting/decrypting transmissions of said information to and from said remote database and remote computer.

14. The method of claim 1 further comprising the step of compressing/decompressing transmissions of said information to and said remote database and remote computer.
